(19) United States
(12) Patent Application Publication
(10) Pub. No.: US 2026/0351222 A1
(43) Pub. Date: Nov. 5, 2026

(54) Removable and Rotatable Pick Plate for Stringed Musical Instruments

(71) Applicant: Timothy Joel Roufa, Tallahassee, FL (US)

(72) Inventor: Timothy Joel Roufa, Tallahassee, FL (US)

(21) Appl. No.: 19/459,948

(22) Filed: Jan. 26, 2026

Related U.S. Application Data
(63) Continuation-in-part of application No. 18/606,058, filed on Mar. 15, 2024.

(51) Int. Cl. G10D 3/173

(52) U.S. Cl. CPC G10D 3/173

(57) ABSTRACT

A removable and rotatable pick plate for playing stringed musical instruments includes a playing portion configured to engage one or more strings and a mounting portion defining a channel between opposing extensions. The channel is dimensioned to removably receive a post while permitting rotation of the pick plate relative thereto, allowing the pick plate to be selectively positioned between a playing position and a storage position while remaining readily accessible to the player.

### CROSS-REFERENCE TO RELATED APPLICATIONS

This application is a continuation-in-part of U.S. Nonprovisional patent application Ser. No. 18/606,058, filed Mar. 15, 2024, which claims the benefit of U.S. Provisional Patent Application No. 63/453,262, filed Mar. 20, 2023. The disclosures of the foregoing applications are incorporated herein by reference to the extent not inconsistent with the present disclosure.

### FIELD OF THE INVENTION

The present invention relates generally to musical accessories and, more particularly, to picks or plectrums and mounting structures for playing stringed musical instruments.

### BACKGROUND OF THE INVENTION

Picks are commonly used to pluck or strum strings on guitars, banjos, mandolins, and similar stringed musical instruments. Conventional picks are typically held between a thumb and finger of a player and are prone to being dropped, repositioned unintentionally, or lost during performance.

Various finger-mounted pick holders and attachment systems have been proposed to address these issues. However, many such systems restrict pick orientation, limit rotation, or require disassembly to replace the pick, thereby interrupting play.

Accordingly, there remains a need for an improved pick structure that can be securely retained on a support while remaining rotatable, removable without tools, and interchangeable during use.

### SUMMARY OF THE INVENTION

The present invention is directed to an improved pick or plectrum for playing a stringed musical instrument. More particularly, the invention relates to a pick plate having a mounting structure that enables removable, rotatable attachment to a post, thereby allowing a pick to be selectively positioned for playing engagement with instrument strings or moved out of the way when not in use, while remaining readily accessible to the player.

In one aspect, the invention comprises a pick plate having a playing portion configured to engage one or more strings of a musical instrument and a mounting portion configured to cooperate with a post. The mounting portion includes one or more extensions that define a channel sized and shaped to receive the post. When mounted on the post, the pick plate is retained on the post while being free to rotate relative thereto.

The channel defined by the extensions permits the pick plate to be removably mounted on the post without tools, allowing a player to intentionally attach, remove, or replace the pick plate without disassembling the post or removing the post from an associated support. The channel may permit sliding engagement, snap-fit engagement, or a combination thereof.

When engaged with the post, the pick plate is rotatable about the post between a playing position and a storage position. In some embodiments, the pick plate is rotatable through at least 180 degrees, and in other embodiments through approximately 360 degrees or more, allowing rapid transitions between different playing techniques during performance.

Advantageously, the pick plate may be interchangeable, such that a plurality of pick plates having different thicknesses, materials, shapes, or playing characteristics may be selectively mounted on the same post. This enables customization of tone and playing feel without requiring changes to the post or its associated support.

In some embodiments, the post may extend from a finger-mounted support configured to be worn on a finger of a player, such as a ring, strap, band, or other support structure. In other embodiments, the post may be supported by alternative mounting structures. The particular configuration of the support is not critical to the invention, as the inventive aspects reside primarily in the structure of the pick plate and its interface with the post.

The invention allows a musical instrument player to avoid dropping or misplacing a pick, to quickly switch between playing styles, and to replace or change picks with minimal interruption. The invention is suitable for use with guitars, banjos, mandolins, and other stringed musical instruments, and the term “pick” as used herein includes plectrums of various shapes and materials.

### BRIEF DESCRIPTION OF THE DRAWINGS

FIG. 1 is a perspective view of a pick plate according to one embodiment of the invention.

FIG. 2 is a rear view of the pick plate of FIG. 1 showing Wings defining a channel configured to receive a post.

FIG. 3 is a view illustrating alignment of the pick plate with a post prior to attachment.

FIG. 4 is a view illustrating engagement between the pick plate and the post.

FIGS. 5A and 5B illustrate the pick plate mounted on the post in a playing position and a rotated storage position, respectively.

FIG. 6 illustrates a finger-mounted pick system including a finger-mounted support, a post, and the pick plate.

### DETAILED DESCRIPTION OF THE INVENTION

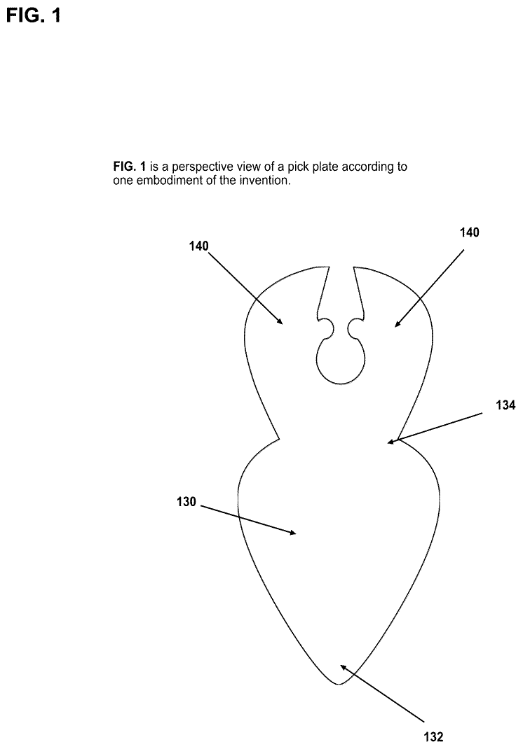

Referring now to the drawings, wherein like reference numerals designate like elements throughout, a pick plate 130 includes a playing portion 134 terminating in a tip 132 configured to engage one or more strings of a musical instrument, as illustrated in FIG. 1. The pick plate 130 further includes a mounting portion positioned opposite the tip 132.

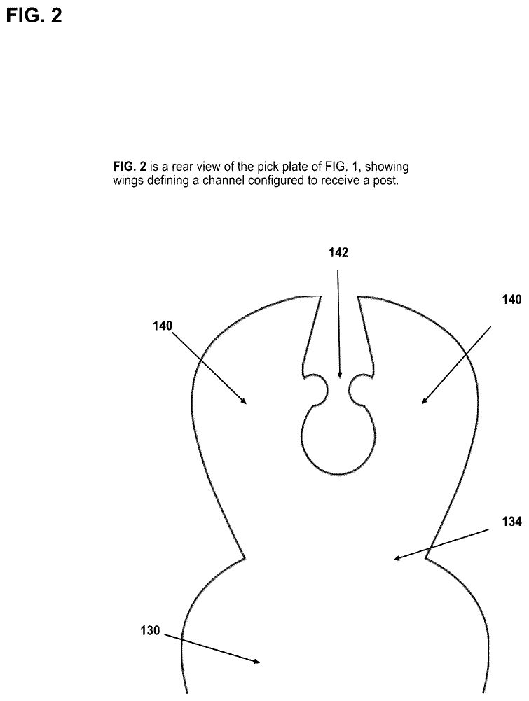

The mounting portion of the pick plate 130 includes at least two extensions 140 spaced apart to define a channel 142 therebetween, as shown in FIGS. 1 and 2. The channel 142 is open along at least one side and is dimensioned to removably receive a post 120. In the illustrated embodiment, the extensions 140 extend generally rearwardly from the playing portion 134.

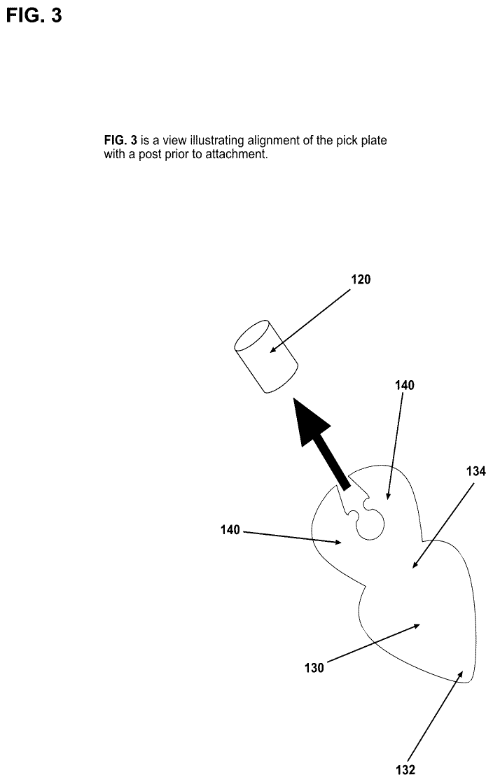

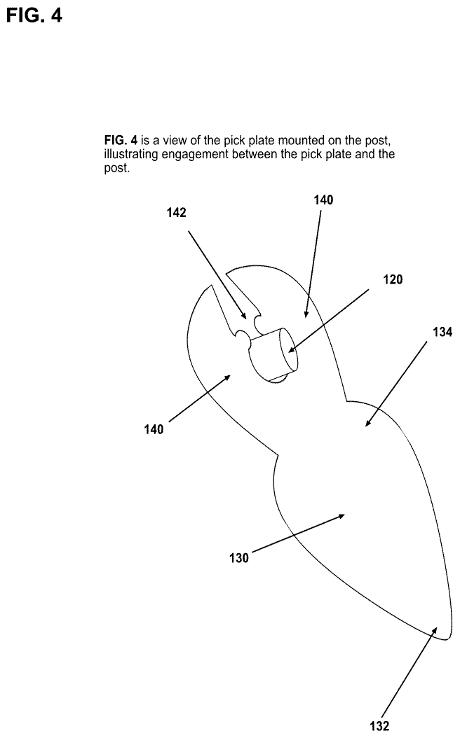

As illustrated in FIGS. 3 and 4, the channel 142 is configured to receive the post 120 by sliding engagement, snap-fit engagement, lateral insertion, or combinations thereof. In some embodiments, at least one of the extensions 140 is resiliently deformable to permit insertion and removal of the post 120.

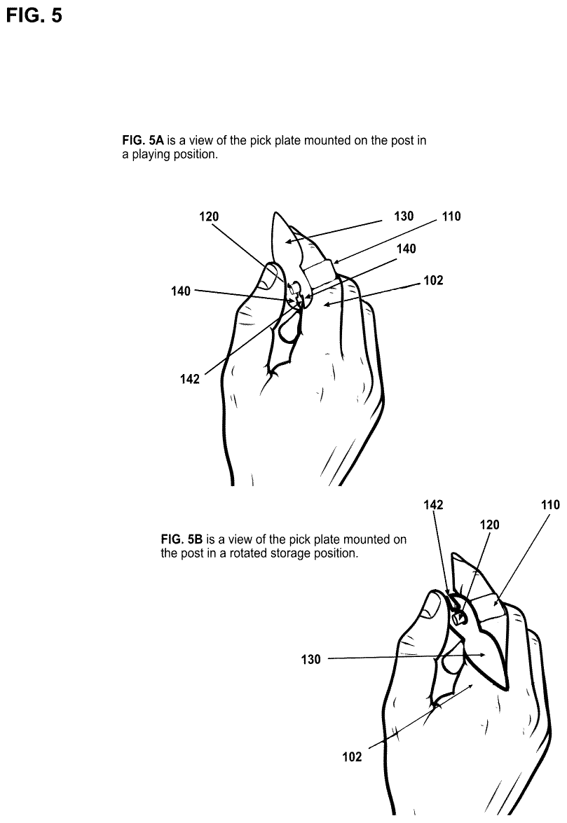

When the post 120 is received within the channel 142, the pick plate 130 is retained on the post 120 while remaining rotatable relative thereto. As shown in FIGS. 5A and 5B, the pick plate 130 may be rotated between a playing position and a storage position. In some embodiments, the pick plate 130 is rotatable through at least 180 degrees and, in other embodiments, through approximately 360 degrees or more.

The pick plate 130 may be intentionally removed from the post 120 without tools and replaced with a different pick plate without removing the post 120 or a finger-mounted support 102, thereby permitting rapid customization of playing characteristics during use.

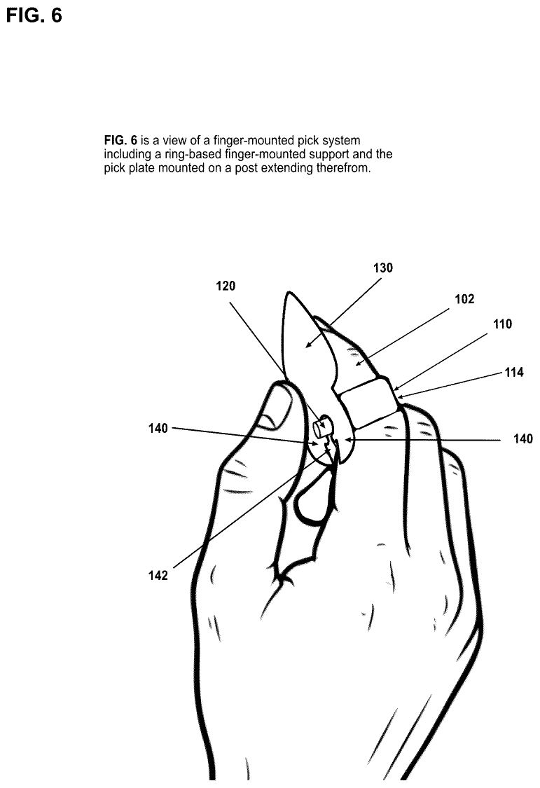

As shown in FIG. 6, the post 120 may extend from a finger-mounted support 102 forming part of a finger-mounted pick system 110 configured to be worn on a finger of a user. The finger-mounted support 102 may include a band portion 114, ring, strap, or other support structure. The pick plate 130 may be formed from polymeric materials, metals, wood, bone, horn, or composite materials.

1. A pick plate for playing a stringed musical instrument, comprising: a playing portion having a tip configured to engage at least one string; and a mounting portion opposite the playing portion, wherein the mounting portion includes at least two extensions spaced apart to define a channel therebetween, the channel being open along at least one side and dimensioned to removably receive a post, wherein, when the post is received within the channel, the pick plate is retained on the post while remaining rotatable relative thereto.

2. A removable and rotatable pick interface, comprising: a pick plate including a channel defined between at least two extensions; and a post configured to be received within the channel, wherein the channel retains the post against unintended disengagement while permitting rotation of the pick plate relative to the post and intentional removal of the pick plate from the post without disassembly of the post.

3. A finger-mounted pick system, comprising: a finger-mounted support configured to be worn on a finger of a user; a post extending from the finger-mounted support; and a pick plate according to claim 1 removably mounted on the post.

4. The pick plate of claim 1, wherein the extensions extend generally rearwardly from the playing portion.

5. The pick plate of claim 1, wherein the channel is configured to receive the post by at least one of a snap-fit engagement, sliding engagement, or lateral insertion.

6. The pick plate of claim 1, wherein the pick plate is rotatable relative to the post through at least 180 degrees.

7. The pick plate of claim 1, wherein the pick plate is rotatable through approximately 360 degrees about the post.

8. The pick plate of claim 1, wherein at least one of the extensions is resiliently deformable to permit insertion and removal of the post.

9. The pick plate of claim 1, wherein the pick plate is removable from the post without tools.

10. The pick plate of claim 1, wherein the pick plate is configured to be removed from the post and replaced with a different pick plate without removing the finger-mounted support.

11. The pick plate of claim 1, wherein the pick plate is formed from a polymeric material.

12. The pick plate of claim 1, wherein the pick plate is formed from a material selected from the group consisting of plastics, metals, wood, bone, horn, and composite materials.
